(19) United States
(12) Patent Application Publication
(10) Pub. No.: US 2026/0084579 A1
(43) Pub. Date: Mar. 26, 2026

(54) SYSTEM FOR CONTROLLING TO CHARGE VEHICLE AND METHOD FOR THE SAME

(71) Applicant: Samsung Display Co., LTD., Yongin-si (KR)

(72) Inventors: YONGSUK LEE, Yongin-si (KR); SEUNG-WON BAEK, Yongin-si (KR); JONGPYO SHIN, Yongin-si (KR); SUJI LEE, Yongin-si (KR); EUNKYUNG LEE, Yongin-si (KR); HYUNWOO LEE, Yongin-si (KR)

(21) Appl. No.: 19/232,209

(22) Filed: Jun. 9, 2025

(30) Foreign Application Priority Data
Sep. 20, 2024 (KR) 10-2024-0127188

(51) Int. Cl. B60L 53/68; B60L 53/62; B60L 53/65; B60L 53/80

(52) U.S. Cl. CPC B60L 53/68; B60L 53/62; B60L 53/65; B60L 53/80; B60L 2240/545; B60L 2240/547; B60L 2240/549

(57) ABSTRACT

A system for controlling to charge a vehicle includes a panel-carrying vehicle including a battery, a battery-replacing unit to receive a plurality of replacing batteries having information about identifiers (“IDs”) which are manually different from each other and a control server to make communication with the panel-carrying vehicle and the battery-replacing unit. The control server receives first battery information of the battery from the panel-carrying vehicle, the control server receives second battery information of the plurality of replacing batteries and unit information of the battery-replacing unit, from the battery-replacing unit, and the control server determines whether the battery of the panel-carrying vehicle is to be replaced, based on the first battery information and the second battery information.

This application claims priority to Korean Patent Application No. 10-2024-0127188, filed on Sep. 20, 2024, and all the benefits accruing therefrom under 35 U.S.C. § 119, the content of which in its entirety is herein incorporated by reference.

### BACKGROUND

### 1. Field

Embodiments of the disclosure described herein relate to a system and a method for controlling to charge a vehicle, which are improved in charging efficiency.

### 2. Description of the Related Art

An automated guided vehicle is also referred to as an autonomous vehicle, and is equipped with an automated guide vehicle using an electromagnetic or optical principle. Accordingly, the automated guided vehicle indicates a vehicle which is driven along a regulated guide path, and has a safety protective function and various transfer carrying functions. As the autonomous vehicle has higher automation and intelligence, the automated guided vehicle has increasingly been used in various places, including warehouse storage and logistics.

The autonomous vehicle may be driven by a battery. When the battery of the autonomous vehicle is discharged, an operation for charging the battery may be performed. In this case, there is desired a manner for efficiently charging the battery to reduce a time for replacing the battery.

### SUMMARY

Embodiments of the disclosure provide a system and a method for controlling to charge a vehicle, which are improved in charging efficiency.

In an embodiment of the disclosure, a system for controlling to charge a vehicle may include a panel-carrying vehicle including a battery, a battery-replacing unit to receive a plurality of replacing batteries having information about identifiers (“IDs”) which are mutually different from each other, and a control server to make communication with the panel-carrying vehicle and the battery-replacing unit. The control server may receive first battery information of the battery from the panel-carrying vehicle, the control server may receive second battery information of the plurality of replacing batteries and unit information of the battery-replacing unit, from the battery-replacing unit, and the control server may determine whether the battery of the panel-carrying vehicle is desired to be replaced, based on the first battery information and the second battery information.

In an embodiment, the unit information may include information about an operating state of the battery-replacing unit.

In an embodiment, the unit information may include information about a mode of the battery-replacing unit, which is selected from among a standby mode, a repairing mode, or a battery-replacing mode.

In an embodiment, the unit information may include information about an average voltage or an average current of the plurality of replacing batteries.

In an embodiment, the battery-replacing unit may include a temperature sensor, and the unit information may include information about an average temperature of the plurality of replacing batteries, which is measured by the temperature sensor.

In an embodiment, the second battery information may include information about an ID of the IDs.

In an embodiment, the second battery information may include information about a voltage or a current of a replacing battery, which corresponds to the information about the ID, among the plurality of replacing batteries.

In an embodiment, the second battery information may include information about whether a replacing battery, which corresponds to the information about the ID, among the plurality of replacing batteries, is replaced for the panel-carrying vehicle.

In an embodiment, the control server may receive the second battery information and the unit information from the battery-replacing unit, at every first time interval.

In an embodiment, a check signal may be transmitted between the control server and the battery-replacing unit.

In an embodiment, the panel-carrying vehicle may move along a first route, which passes through the battery-replacing unit, and a second route which does not pass through the battery-replacing unit, the panel-carrying vehicle may further include a camera, and the panel-carrying vehicle may compare a current voltage value of the battery with a running voltage value of the second route and determines to move along the first route or the second route, when the camera recognizes an external predetermined image.

In an embodiment, the panel-carrying vehicle may be provided in plural, each of the plurality of panel-carrying vehicles may move along a first route, which passes through the battery-replacing unit, and a second route which passes through a parking area, in which the plurality of panel-carrying vehicles stand by without passing through the battery-replacing unit, the control server may check a state of the battery of each of the plurality of panel-carrying vehicles, based on the first battery information, and the control server may instruct (allow) at least one second panel-carrying vehicle, which is placed before a first panel-carrying vehicle having the battery desired to be replaced, among the plurality of panel-carrying vehicles to move to a last row of the parking area, along the second route, and instruct (allow) the first panel-carrying vehicle having the battery desired to be replaced to move along the first route.

In an embodiment, a method for controlling to charge a vehicle, may include providing a plurality of panel-carrying vehicles including a battery, a battery-replacing unit to receive a replacing battery, and a control server, reporting, by the battery-replacing unit, battery information and unit information to the control server, at every first time interval, determining whether the replacing battery is replaceable, determining a replacing panel-carrying vehicle, which has the battery desired to be replaced, among the plurality of panel-carrying vehicles, selecting, by the control server, the battery-replacing unit next (adjacent) to the replacing panel-carrying vehicle, based on the unit information, and transmitting a moving instructing signal to the replacing panel-carrying vehicle, instructing (allowing) the replacing panel-carrying vehicle to move to the battery-replacing unit next (adjacent) to the replacing panel-carrying vehicle, and transmitting, by the battery-replacing unit, information about the replacing battery, which is replaced, to the control server.

In an embodiment, the battery-replacing unit may include a temperature sensor, and the unit information may include information about a temperature of the battery-replacing unit, which is measured by the temperature sensor.

In an embodiment, the replacing battery may have information about an ID, and the battery information may include the information about the ID.

In an embodiment, the battery information may include information about a voltage or a current of the replacing battery.

In an embodiment, the panel-carrying vehicle may move along a first route, which passes through the battery-replacing unit, or a second route which does not pass through the battery-replacing unit, and the panel-carrying vehicle may include a camera.

In an embodiment, the panel-carrying vehicle may compare a current voltage value of the battery with a running voltage value for the second route and determines to move along the first route or the second route, when the camera recognizes an external predetermined node.

In an embodiment, the panel-carrying vehicle may include a plurality of panel-carrying vehicles, each of the plurality of panel-carrying vehicles may move along a first route, which passes through the battery-replacing unit, and a second route which passes through a parking area, in which the plurality of panel-carrying vehicles stand by without passing through the battery-replacing unit, and the control server may check a state of the battery of each of the plurality of panel-carrying vehicles.

In an embodiment, the method may further include instructing (allowing) at least one second panel-carrying vehicle, which is placed before a first panel-carrying vehicle having the battery desired to be replaced, among the plurality of panel-carrying vehicles to move to a last row of the parking area, along the second route, and instructing (allowing) the first panel-carrying vehicle having the battery desired to be replaced to move along the first route.

### BRIEF DESCRIPTION OF THE DRAWINGS

The above and other embodiments, advantages and features of the disclosure will become apparent by describing in detail embodiments thereof with reference to the accompanying drawings.

FIG. 1 illustrates an embodiment of a vehicle charging control system according to the disclosure.

FIG. 2 is a flowchart illustrating an embodiment of a vehicle charging control method according to the disclosure.

FIG. 3 illustrates a manner for transmitting/receiving a signal between a control server and a battery-replacing unit.

FIG. 4 illustrates a manner for transmitting/receiving a signal between a control server and a battery-replacing unit.

FIG. 5 illustrates an embodiment of a vehicle charging control system according to the disclosure.

FIG. 6 is a flowchart illustrating an embodiment of a vehicle charging control method according to the disclosure.

FIG. 7 illustrates an embodiment of a vehicle charging control system according to the disclosure.

FIG. 8 is a flowchart illustrating an embodiment of a vehicle charging control method according to the disclosure.

### DETAILED DESCRIPTION

In the specification, the expression that a first component (or region, layer, or part) is “on”, “connected to”, or “coupled to” a second component refers to that the first component is directly on, connected to, or coupled to the second component or refers to that a third component is interposed therebetween.

The same reference numeral will be assigned to the same component. In addition, in drawings, thicknesses, proportions, and dimensions of components may be exaggerated to describe the technical features effectively. The term “and/of” includes any and all combinations of one or more of associated components

Although the terms “first”, or “second” may be used to describe various components, the components should not be construed as being limited by the terms. The terms are only used to distinguish one component from another component. For example, without departing from the scope and spirit of the disclosure, a first component may be referred to as a second component, and similarly, the second component may be referred to as the first component. The singular forms are intended to include the plural forms unless the context clearly indicates otherwise.

In addition, the terms “under”, “at a lower portion”, “above”, “an upper portion” are used to describe the relationship between components illustrated in drawings. The terms are relative and will be described with reference to a direction indicated in the drawing.

It will be further understood that the terms “comprise,” “include,” or “including,” or “have” or “having” specify the presence of stated features, numbers, steps, operations, components, parts, or the combination thereof, but do not preclude the presence or addition of one or more other features, numbers, steps, operations, components, components, and/or the combination thereof.

The terms such as “unit” refer to a software component or a hardware component to perform a predetermined function. The hardware component may include field-programmable gate array (“FPGA”) or an application-specific integrated circuit (“ASIC”). The software component may refer to an executable code and/or data used by the executable code in an addressable storage medium. Accordingly, software components may be object-oriented software components, for example, class components, and task components, and may include processes, functions, properties, procedures, subroutines, program code segments, driver data, firmware, micro-codes, circuits, data, database, data structures, tables, arrangements or variables.

Unless otherwise defined, all terms (including technical terms and scientific terms) used in the specification have the same meaning as commonly understood by one skilled in the art to which the disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Hereinafter, embodiments of the disclosure will be described with reference to accompanying drawings.

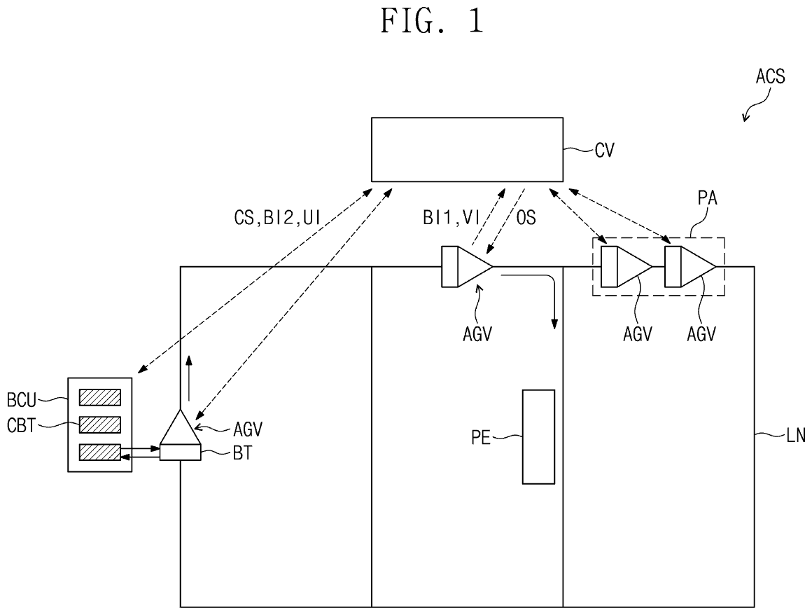

FIG. 1 illustrates an embodiment of a system for controlling to charge a vehicle according to the disclosure.

Referring to FIG. 1, a system (hereinafter, a vehicle charging control system ACS) for controlling to charge a vehicle may include a panel-carrying vehicle AGV, a battery-replacing unit BCU, and a control server CV.

A board may be loaded in the panel-carrying vehicle AGV. The panel-carrying vehicle AGV may store and/or carry the loaded board. In an embodiment, the panel-carrying vehicle AGV may safely carry a board, which is provided after one process, to a place for another process while protecting the board from an external impact, for example.

The panel-carrying vehicle AGV may include a battery BT. The battery BT may supply power desired for the operation of the panel-carrying vehicle AGV.

The panel-carrying vehicle AGV may be provided in plural. Each of the plurality of panel-carrying vehicles AGV may move along a specified guide path LN. The plurality of panel-carrying vehicles AGV may move along the specified guide path LN in a uni-direction. The guide path LN may be a moving path defined to carry the board using process equipment PE.

One of guide paths LN may be a path directed to a parking area PA. The parking area PA may be an area for standing by a vehicle, which does not carry a board, among the plurality of panel-carrying vehicles AGV.

According to the disclosure, the vehicle, which does not carry the board, among the plurality of panel-carrying vehicles AGV may be placed in the parking area PA without running. The vehicle, which does not carry the board, may prevent a battery from being discharged. Accordingly, the vehicle charging control system ACS improved in the operating efficiency of the battery may be provided.

The battery-replacing unit BCU may receive a plurality of replacing batteries CBT. The plurality of replacing batteries CBT may have information about mutually different identifiers (IDs). In an embodiment, one battery-replacing unit BCU may receive three or four replacing batteries CBT, for example. However, this is provided only for the illustrative purpose. In another embodiment, a receiving capacity of the battery-replacing unit BCU in the disclosure is not limited thereto.

In an embodiment of the disclosure, the battery-replacing unit BCU may be provided in plural. The plurality of battery-replacing units BCU may be placed on the guide path LN.

The control server CV may make communication with the plurality of panel-carrying vehicles AGV and the battery-replacing unit BCU. The control server CV may make communication with the plurality of panel-carrying vehicles AGV and the battery-replacing unit BCU through WiFi. However, this is provided only for the illustrative purpose. In an embodiment, according to the disclosure, a communication scheme such as Ethernet, long range (“LoRA”), machine-to-machine (“M2M”), third generation (“3G”), fourth generation (“4G”), long-term evolution (“LTE”), LTE for machines (“LTE-M”), Bluetooth®, or wireless fidelity (“WiFi”) Direct (“WFD”) may be used, for example.

The control server CV may receive first battery information BI1 about the battery BT from the panel-carrying vehicle AGV.

The control server CV may receive vehicle information VI from the panel-carrying vehicle AGV.

The control server CV may transmit a moving instructing signal OS to the panel-carrying vehicle AGV.

The control server CV may receive second battery information BI2 of the plurality of replacing batteries CBT from the battery-replacing unit BCU.

The control server CV may receive unit information UI of the battery-replacing unit BCU from the battery-replacing unit BCU.

A check signal CS may be transmitted or received between the control server CV and the battery-replacing unit BCU.

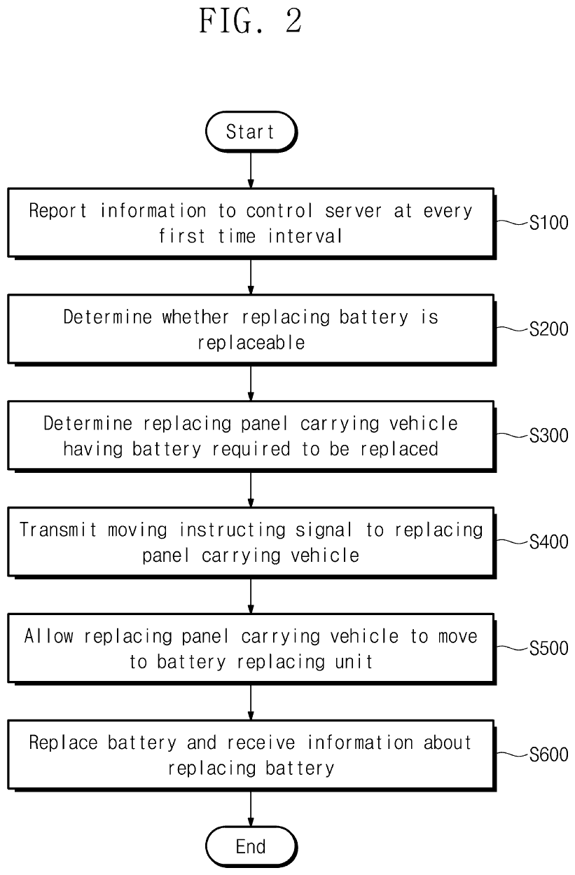

FIG. 2 is a flowchart illustrating an embodiment of a method (hereinafter, a vehicle charging control method) for controlling to charge a vehicle according to the disclosure.

Referring to FIGS. 1 and 2, the battery-replacing unit BCU may report the second battery information BI2 and the unit information UI to the control server CV at every first time interval.

Each of the plurality of panel-carrying vehicles AGV may report the first battery information BI1 and the vehicle information VI to the control server CV at every predetermined time interval (S100).

The control server CV may determine whether each of the plurality of replacing batteries CBT is replaceable, based on the second battery information BI2 (S200).

The control server CV may determine a panel-carrying vehicle (hereinafter, replacing panel-carrying vehicle) AGV, which has a battery BT desired to be replaced, among the panel-carrying vehicles AGV, based on the first battery information BI1 (S300).

The control server CV may select a battery-replacing unit BCU next (adjacent) to the replacing panel-carrying vehicle AGV, based on the vehicle information VI and the unit information UI. The control server CV may transmit a moving instructing signal OS to the replacing panel-carrying vehicle AGV (S400). The moving instructing signal OS may be a signal for instructing the replacing panel-carrying vehicle AGV to move to the battery-replacing unit BCU next (adjacent) to the replacing panel-carrying vehicle AGV.

The replacing panel-carrying vehicle AGV may move to the neighboring (adjacent) battery-replacing unit BCU along the guide path LN (S500).

The battery-replacing unit BCU may replace the battery BT, when the replacing panel-carrying vehicle AGV arrives at the battery-replacing unit BCU. The battery-replacing unit BCU may collect the battery BT discharged, and may introduce the replacing battery CBT into the replacing panel-carrying vehicle AGV. The operation may be automatically performed.

The replacing panel-carrying vehicle AGV may move again along the guide path LN after the replacing battery CBT fully charged is introduced into the replacing panel-carrying vehicle AGV.

The battery-replacing unit BCU may transmit the second battery information BI2 about the replacing battery CBT, which is replaced, to the control server CV (S600),

Thereafter, the panel-carrying vehicle AGV may move along the guide path LN again, may load a board therein, and store and/or transfer the loaded board.

According to the disclosure, the control server CV may obtain the state of the battery BT of the panel-carrying vehicle AGV, based on the first battery information BI1 received therein, and may obtain the state of the replacing battery CBT, based on the second battery information BI2. The control server CV may recognize the replacing battery CBT finished in charging, and may recognize the panel-carrying vehicle AGV having the battery BT which is discharged and desired to be replaced. The control server CV may recognize the position of the panel-carrying vehicle AGV, based on the unit information UI, and may recognize the position of the battery-replacing unit BCU, based on the unit information UI. The control server CV may transmit the moving instructing signal OS, which is to instruct moving, to the battery-replacing unit BCU next (adjacent) to the panel-carrying vehicle AGV, such that the panel-carrying vehicle AGV easily replaces the battery BT. The control server CV may perform the operation for efficiently replacing the battery, based on the first battery information BI1 and the second battery information BI2. Accordingly, the system and the method for controlling to charge the vehicle, which are improved in charging efficiency, may be provided.

Accordingly, the time desired for replacing the battery BT of the panel-carrying vehicle AGV may be reduced, and the line production in the process may be increased.

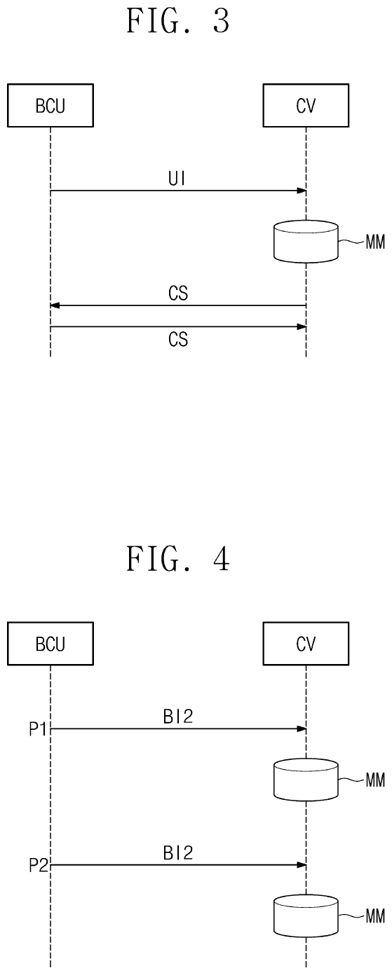

FIG. 3 illustrates a manner for transmitting/receiving a signal between a control server and a battery-replacing unit.

Referring to FIGS. 1 and 3, the battery-replacing unit BCU may report the unit information UI to the control server CV (S100, refer to FIG. 2). The battery-replacing unit BCU may transmit the unit information UI at every first time interval from a moment at which power is on. In an embodiment, the first time interval may be 30 seconds, for example. However, this is provided only for the illustrative purpose. In another embodiment, the first time interval is not limited thereto.

In an alternative embodiment, the control server CV may transmit a request signal to the battery-replacing unit BCU. The battery-replacing unit BCU may report the unit information UI, in response to the request signal.

When the control server CV first receives the unit information UI, the control server CV may set the state of the battery-replacing unit BCU to a connecting state.

The control server CV may include a memory MM. The control server CV may receive the unit information UI and store the unit information UI in the memory MM.

When the control server CV receives the last unit information UI and after the first time has elapsed, it receives the next unit information UI, the control server CV may update the unit information UI stored in the memory MM and may maintain the connecting state.

When not receiving the unit information UI, which next comes, even though the first time interval is elapsed from the receiving of the unit information UI which last comes, the control server CV may set the state of the battery-replacing unit BCU to a disconnecting state.

When the state of the battery-replacing unit BCU is the disconnecting state, the control server CV may control the panel-carrying vehicle AGV to be prevented from moving to the relevant battery-replacing unit BCU.

A signal transmitted/received between the battery-replacing unit BCU and the control server CV may be transmitted/received based on a predetermined protocol. In an embodiment, the unit information UI may have the value of ‘A901B110000’, for example.

The first value of the predetermined protocol may have ‘A’ indicating a value for the transmission to the control server CV.

The second value to the fourth value of the predetermined protocol may indicate an identification number of the battery-replacing unit BCU. In an embodiment, the battery-replacing unit BCU may have the identification number of ‘901’, for example.

The fifth value of the predetermined protocol may indicate the type of information. In an embodiment, for the state information of the battery-replacing unit BCU or the state information of the replacing battery CBT, the fifth value may be defined as ‘B’, for example.

The sixth value of the predetermined protocol may indicate the state of the battery-replacing unit BCU. In an embodiment, when the battery-replacing unit BCU operates normally, the sixth value may have the value of ‘1’, for example. When the battery-replacing unit BCU operates erroneously, the sixth value may have the value of ‘0’.

When receiving the unit information UI having ‘0’ in the sixth value, the control server CV may control the panel-carrying vehicle AGV to be prevented from moving to the relevant battery-replacing unit BCU.

The seventh value of the predetermined protocol may indicate the type of information. The eighth value and the ninth value of the predetermined protocol may indicate detailed information.

The unit information UI may include information about the operating state of the battery-replacing unit BCU. In this case, the seventh value may have the value of ‘1’.

On the assumption that the seventh value is ‘1’, the eighth value and the ninth value may have ‘00’ when the battery-replacing unit BCU is in a standby state, and may have ‘01’ when the battery-replacing unit BCU is in an operating state.

The unit information UI may include information about a mode of the battery-replacing unit BCU, which is selected from among a standby mode, a repairing mode, or a battery-replacing mode. In this case, the seventh value may have the value of ‘2’.

On the assumption that the seventh value may have the value of ‘2’, the eighth value and the ninth value may have ‘00’ in the standby mode, may have ‘01’ in the repairing mode, and may have ‘02’ in the battery-replacing mode.

The unit information UI may include information about an average voltage or an average current of the plurality of replacing batteries CBT. In this case, the seventh value may have the value of ‘3’ or ‘4’.

When the seventh value is ‘3’ or ‘4’, the eighth value and the ninth value may have two digits before a decimal point in a voltage value or a current value.

The tenth value and the eleventh value of the predetermined protocol may be values for indicating two digits after a decimal point in a voltage value or a current value.

The battery-replacing unit BCU may include a temperature sensor to measure the temperature of each of the plurality of replacing batteries CBT.

The unit information UI may include information about an average temperature of the plurality of replacing batteries CBT, which is measured by the temperature sensor. In this case, the seventh value may have the value of ‘5’.

On the assumption that the seventh value may have the value of ‘5’, the eighth value and the ninth value may have ‘00’ for indicating a normal temperature, ‘01’ for indicating a temperature lower than the normal temperature, or ‘02’ for indicating a temperature higher than the normal temperature.

In the battery-replacing mode, transmitting unit information UI including information about a voltage or a current and temperature information may be omitted. Accordingly, an amount of information about a signal may be reduced. In the battery-replacing mode, individual information about each of the replacing batteries CBT may be received through the second battery information BI2, instead of the unit information UI.

Accordingly, the unit information UI having the value of ‘A901B110000’ may be transmitted to the control server CV, which refers to that the battery-replacing unit BCU having the identification number of ‘901’ transmits the information about the operating state in the state information. In this case, the unit information UI may be a signal for indicating that the battery-replacing unit BCU operates normally and is in the standby state at a current time point.

Whenever the first time interval is elapsed, the battery-replacing unit BCU may transmit the second battery information BI2 in order of ‘A901B12XXXX’, ‘A901B13XXXX’, ‘A901B14XXXX’, and ‘A901B15XXXX’.

The check signal CS may be transmitted or received between the control server CV and the battery-replacing unit BCU. The fifth value of the protocol of the check signal CS may be defined as ‘H’. In an embodiment, the check signal CS may have the value of ‘A901HXXXXXX’, for example.

FIG. 4 illustrates a manner for transmitting/receiving a signal between a control server and a battery-replacing unit. In the following description made with reference to FIG. 4, the same reference numeral will be assigned to a component which has been already described with reference to FIG. 3, and the details thereof will be omitted.

Referring to FIGS. 1 and 4, the battery-replacing unit BCU may report the second battery information BI2 to the control server CV (S100, refer to FIG. 2). The battery-replacing unit BCU may transmit the second battery information BI2, at every first time interval from a moment at which the power is on. The operation may be also referred to as a first operation P1.

The control server CV may receive the second battery information BI2 and store the second battery information BI2 in the memory MM.

A signal transmitted/received between the battery-replacing unit BCU and the control server CV may be transmitted/received based on a predetermined protocol. In an embodiment, the second battery information BI2 may have the value of ‘A901BAZ31XX’, for example.

The fifth value of the predetermined protocol may indicate the type of information. In an embodiment, for the state information of the battery-replacing unit BCU or the state information of the replacing battery CBT, the fifth value may be defined ‘B’, for example.

The second battery information BI2 may include information about an ID. The sixth value and the seventh value of the predetermined protocol may indicate an ID of each of the plurality of replacing batteries CBT. In an embodiment, the sixth value may be defined as one of ‘A’ to ‘Z’. The seventh value may be defined as one of ‘O’ to ‘9’ and ‘A’ to ‘Z’, for example. In an embodiment of the disclosure, one of the plurality of replacing batteries CBT may have information about the ID of ‘AZ’.

The second battery information BI2 may include information about a voltage or a current of a replacing battery, which corresponds to the information about the ID, among the plurality of replacing batteries CBT. The eighth value of the predetermined protocol may indicate the value of ‘3’ or ‘4’. The eighth value of ‘3’ may indicate the voltage, and the eighth value of ‘4’ may indicate the current.

When the eighth value is ‘3’ or ‘4’, the ninth value may indicate a slot ID of the battery-replacing unit BCU. In other words, the ninth value may indicate a slot of the battery-replacing unit BCU, in which the relevant replacing battery CBT is stored.

When the eighth value is ‘3’ or ‘4’, the tenth value and the eleventh value may be values for indicating two digits of an integer value in a voltage value or a current value.

When the eighth value is ‘5’, the ninth value may indicate a slot ID of the battery-replacing unit BCU.

On the assumption that the eighth value is ‘5’, the tenth value and the eleventh value may have ‘00’ for indicating a normal temperature, ‘01’ for indicating a temperature lower than the normal temperature, or ‘02’ for indicating a temperature higher than the normal temperature.

Accordingly, the second battery information BI2 having the value of ‘A901BAZ31XX’ may be transmitted to the control server CV, which refers to that the battery-replacing unit BCU having the identification number of ‘901’ transmits the state information of the replacing battery CBT. The second battery information BI2 may be a signal for indicating that the voltage of the replacing battery CBT having the information about the ID of ‘AZ’ has an integer value of ‘XX’.

The battery-replacing unit BCU may transmit the second battery information BI2 in order of ‘A901BAZ41XX’, ‘A901BAZ51XX’, ‘A901BAZ32XX’, ‘A901BAZ42XX’, and ‘A901BAZ52XX’, whenever the first time interval is elapsed.

The control server CV may easily receive information about each of the plurality of replacing batteries CBT through the second battery information BI2 and may store the information in the memory MM.

An operation for replacing the battery BT with the replacing battery CBT may be performed between the battery-replacing unit BCU and the replacing panel-carrying vehicle AGV. The operation may be also referred to as a second operation P2.

A signal transmitted/received between the battery-replacing unit BCU and the control server CV may be transmitted/received based on a predetermined protocol. In an embodiment, the second battery information BI2 may have the value of ‘A901BAZ0100’, for example.

The second battery information BI2 may include information about whether the replacing battery, which corresponds to the information about the ID, among the plurality of replacing batteries CBT is replaced for the panel-carrying vehicle AGV. The eighth value and the ninth value of the predetermined protocol may indicate whether replacing is performed. The eighth value and the ninth value of ‘01’ may indicate information that replacing is started, and the eighth value and the ninth value of ‘02’ may indicate information that replacing is terminated.

Accordingly, the second battery information BI2 having ‘A901BAZ0100’ may be a signal transmitted to the control server CV. The signal may indicate that the battery-replacing unit BCU having the identification number of ‘901’ is used for a replacing work, and that the replacement of the replacing battery CBT having the information about the ID of ‘AZ’ starts.

Thereafter, when the replacing is terminated, the battery-replacing unit BCU may transmit the second battery information BI2 having the value of ‘A901BAZ0200’ to the control server CV.

The control server CV may easily receive information about each of the plurality of replacing batteries CBT through the second battery information BI2 and may store the information in the memory MM.

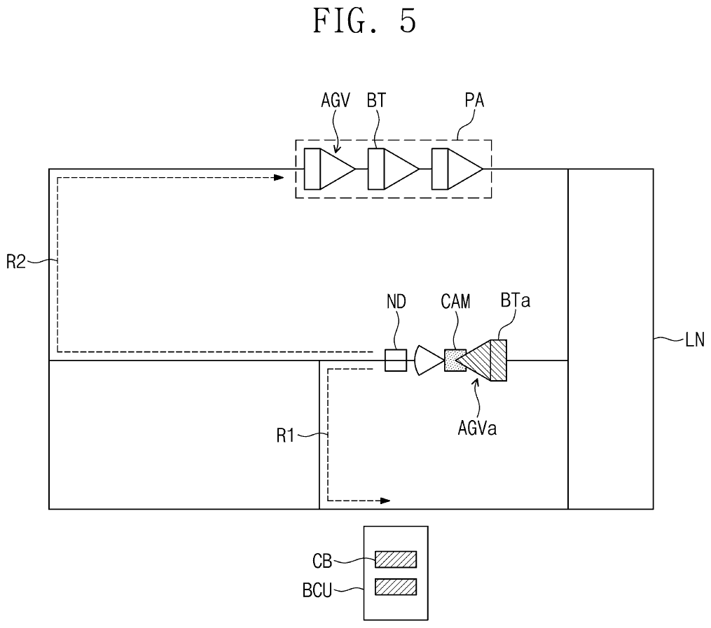

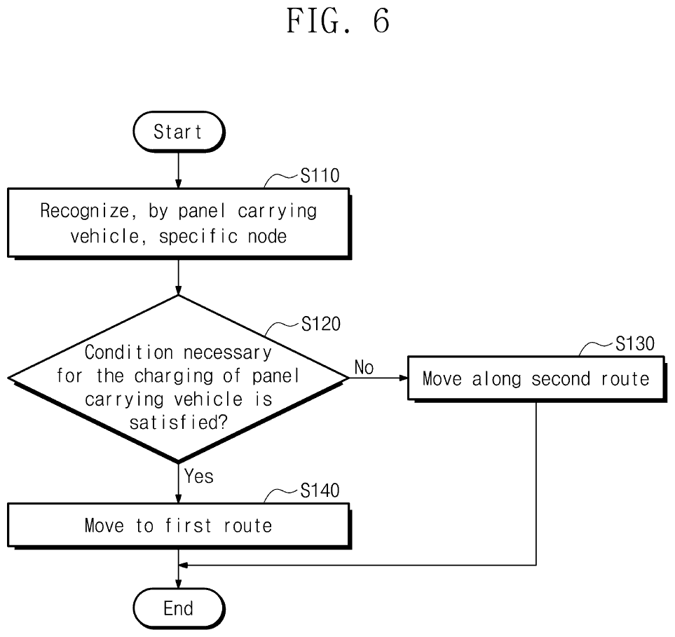

FIG. 5 is a view illustrating an embodiment of a vehicle charging control system according to the disclosure, and FIG. 6 is a flowchart illustrating an embodiment of a vehicle charging control method according to the disclosure.

Referring to FIGS. 1, 2, 5, and 6, the battery-replacing unit BCU may report the second battery information BI2 and the unit information UI, to the control server CV, at every first time interval (S100).

Each of the plurality of panel-carrying vehicles AGV may further include a camera CAM. Some of the plurality of panel-carrying vehicles AGV may be placed in the parking area PA. One panel-carrying vehicle AGVa among the plurality of panel-carrying vehicles AGV may move along a guide path LN.

The panel-carrying vehicle AGVa may move along a first route R1 passing through the battery-replacing unit BCU and a second route R2 which does not pass through the battery-replacing unit BCU. The second route R2 may be a route in which the panel-carrying vehicle AGVa is running currently.

The panel-carrying vehicle AGVa may recognize an external predetermined node ND through the camera CAM (S110). The predetermined node ND may be provided in the form of ‘QR code’.

The panel-carrying vehicle AGVa may generate information based on the predetermined node ND. It is determined whether the panel-carrying vehicle AGVa satisfies a condition desired for the charging when recognizing the predetermined node ND (S120).

The condition desired for the charging may be obtained by comparing a current voltage value and a running voltage value of a battery BTa of the panel-carrying vehicle AGVa. The running voltage value may be a voltage desired for running along the route in which the panel-carrying vehicle AGVa is running currently. In other words, the current running voltage value may be a voltage desired for running along the second route R2. In an embodiment, the running voltage value may be 24.5 volts (V). The running voltage value may be previously stored in a memory of the panel-carrying vehicle AGVa, for example.

In an embodiment, when the current voltage value is greater than a value, which obtained by adding a predetermined voltage to the running voltage value, it may be defined that the condition desired for the charging is not satisfied, for example. In this case, the predetermined voltage may be 0.5 V. In an embodiment, when the current voltage value is 25.3 V, it may be determined that the condition desired for the charging is not satisfied, for example.

When the condition desired for the charging is not satisfied, the panel-carrying vehicle AGVa may move along the second route R2 (S130).

In an embodiment, when the current voltage value is less than the value obtained by adding the predetermined voltage to the running voltage value, it may be defined that the condition desired for the charging is satisfied. In this case, the battery BTa of the panel-carrying vehicle AGVa may be desired to be replaced, for example. In an embodiment, when the current voltage value is 24.9 V, it may be determined that the condition desired for the charging is satisfied, for example.

When the condition desired for the charging is satisfied, the panel-carrying vehicle AGVa may move to the first route R1 (S140).

The control server CV may determine whether each of the plurality of replacing batteries CBT is replaceable, based on the second battery information BI2, after the panel-carrying vehicle AGVa moves to the first route R1 (S200).

In the situation in which the plurality of replacing batteries CBT received in the battery-replacing unit BCU are difficult to be replaced, the control server CV may correct the first route R1, such that the first route R1 includes another battery-replacing unit BCU next (adjacent) to the battery-replacing unit BCU.

The control server CV may transmit a moving instructing signal OS to the replacing panel-carrying vehicle AGVa, such that the replacing panel-carrying vehicle AGVa moves along the first route R1 (S400).

Thereafter, the vehicle charging control system ACS may operate in the vehicle charging control method according to the disclosure.

According to the disclosure, the panel-carrying vehicle AGVa, which has arrived at the predetermined node ND, may self-determine the condition desired for charging. The panel-carrying vehicle AGVa may move along the first route R1, when the battery BTa is desired to be replaced. The panel-carrying vehicle AGVa may move along the first route R1, which is previously defined, to easily replace the battery BTa. Accordingly, the vehicle charging control system ACS and the vehicle charging control method, which are improved in charging efficiency may be provided.

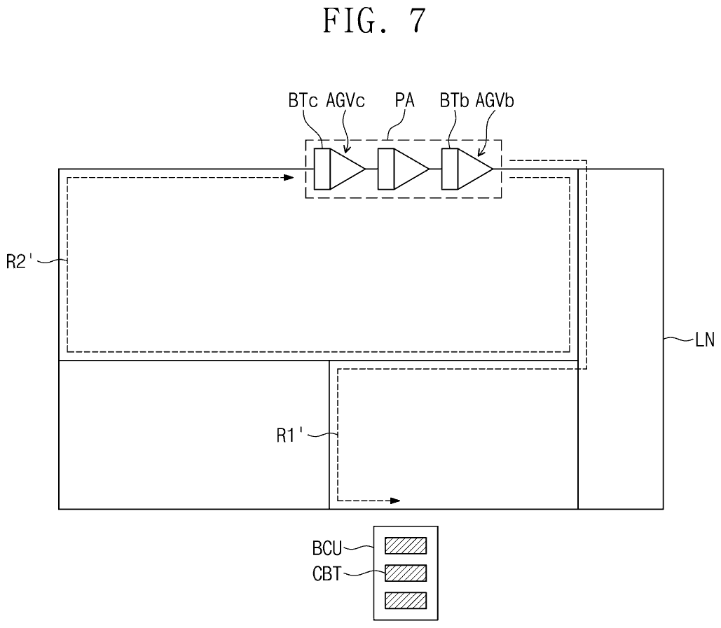

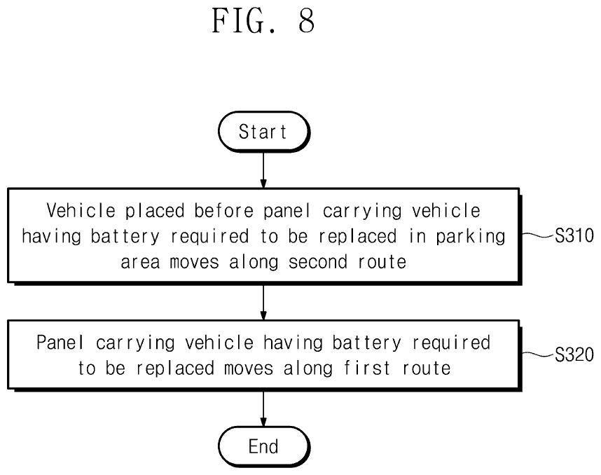

FIG. 7 is a view illustrating an embodiment of a vehicle charging control system according to the disclosure, and FIG. 8 is a flowchart illustrating an embodiment of a vehicle charging control method according to the disclosure.

Referring to FIGS. 1, 2, 7, and 8, the battery-replacing unit BCU may report the second battery information BI2 and the unit information UI, to the control server CV, at every first time interval (S100).

The control server CV may determine whether each of the plurality of replacing batteries CBT is replaceable, based on the second battery information BI2 (S200).

Each of a plurality of panel-carrying vehicles AGV may move along a first route R1′ passing through the battery-replacing unit BCU and a second route R2′ which passes through the parking area PA instead of passing through the battery-replacing unit BCU.

The plurality of panel-carrying vehicles AGV may be aligned in line with each other in the parking area PA. The plurality of panel-carrying vehicles AGV disposed in the parking area PA may operate in a First In First Out (“FIFO”) scheme.

The plurality of panel-carrying vehicles AGV may include a panel-carrying vehicle AGVb having a battery BTb which is not desired to be replaced, and a panel-carrying vehicle AGVc having a battery BTc which is desired to be replaced. The panel-carrying vehicle AGVc having the battery BTc which is desired to be placed may be also referred to as a first panel-carrying vehicle AGVc. The panel-carrying vehicle AGVb having the battery BTb which is not desired to be placed may be also referred to as a second panel-carrying vehicle AGVb.

The control server CV may determine the panel-carrying vehicle AGVc, based on the first battery information BI1 (S300).

At least one panel-carrying vehicle AGVb placed before the panel-carrying vehicle AGVc in the parking area PA may move along a second route R2′ (S310). The at least one panel-carrying vehicle AGVb may move to the last row of the parking area PA along the second route R2.

The panel-carrying vehicle AGVc may move along the first route R1′. The panel-carrying vehicle AGVc may arrive at the battery-replacing unit BCU along the first route R1′ (S310). For the panel-carrying vehicle AGVc, the battery BTc may be replaced with the replacing battery CBT.

Thereafter, the vehicle charging control system ACS may operate in the vehicle charging control method according to the disclosure.

According to the disclosure, when the battery BTc of the panel-carrying vehicle AGVc placed in the last row is desired to be replaced, the battery BTb of the panel-carrying vehicle AGVb, which is placed in the front of the panel-carrying vehicle AGVc and has the battery BTb not desired to be replaced, may move along the second route R2′ and may be rearranged such that the panel-carrying vehicle AGVc easily moves. The panel-carrying vehicle AGVc having the battery BTc, which is desired be replaced is prevented from being discharged due to congestion. Accordingly, the vehicle charging control system ACS and the vehicle charging control method which are improved in charging efficiency, may be provided.

As described above, the control server may obtain the state of the battery of the panel-carrying vehicle, based on the first battery information received, and obtain the state of the replacing battery based on the second battery information. The control server may recognize the replacing battery finished in the charging operation, and may recognize the panel-carrying vehicle having a discharged battery desired to be replaced. The control server may recognize the position of the panel-carrying vehicle, based on the unit formation, and may recognize the position of the battery-replacing unit, based on the unit information. The control server may transmit the moving instructing signal for instructing the battery-replacing unit, which is next (adjacent) to the panel-carrying vehicle, to move, such that the panel-carrying vehicle easily replaces the battery. The control server may perform the operation for efficiently replacing the battery, based on the first battery information and the second battery information. Accordingly, the system and the method for controlling to charge the vehicle, which are improved in charging efficiency, may be provided.

Although an embodiment of the disclosure has been described for illustrative purposes, those skilled in the art will appreciate that various modifications, and substitutions are possible, without departing from the scope and spirit of the disclosure as disclosed in the accompanying claims. Accordingly, the technical scope of the preset disclosure is not limited to the detailed description of this specification, but should be defined by the claims.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. A system for controlling to charge a vehicle, the system comprising:
a panel-carrying vehicle including a battery;
a battery-replacing unit configured to receive a plurality of replacing batteries having an information about identifiers which are mutually different from each other; and
a control server configured to make communication with the panel-carrying vehicle and the battery-replacing unit,
wherein the control server receives a first battery information of the battery from the panel-carrying vehicle,
wherein the control server receives a second battery information of the plurality of replacing batteries and a unit information of the battery-replacing unit, from the battery-replacing unit, and
wherein the control server determines whether the battery of the panel-carrying vehicle is to be replaced, based on the first battery information and the second battery information.

2. The system of claim 1, wherein the unit information includes:
an information about an operating state of the battery-replacing unit.

3. The system of claim 1, wherein the unit information includes:
an information about a mode of the battery-replacing unit, which is selected from among a standby mode, a repairing mode, or a battery-replacing mode.

4. The system of claim 1, wherein the unit information includes:
an information about an average voltage or an average current of the plurality of replacing batteries.

5. The system of claim 1, wherein the battery-replacing unit includes:
a temperature sensor, and
wherein the unit information includes:
an information about an average temperature of the plurality of replacing batteries, which is measured by the temperature sensor.

6. The system of claim 1, wherein the second battery information includes the information about an identifier of the identifiers.

7. The system of claim 6, wherein the second battery information includes:
an information about an average voltage or an average current of a replacing battery, which corresponds to the information about the identifier, among the plurality of replacing batteries.

8. The system of claim 6, wherein the second battery information includes an information about whether a replacing battery, which corresponds to the information about the identifier, among the plurality of replacing batteries, is replaced for the panel-carrying vehicle.

9. The system of claim 1, wherein the control server receives the second battery information and the unit information from the battery-replacing unit, at every first time interval.

10. The system of claim 1, wherein a check signal is transmitted/received between the control server and the battery-replacing unit.

11. The system of claim 1, wherein the panel-carrying vehicle moves along a first route, which passes through the battery-replacing unit, and a second route which does not pass through the battery-replacing unit,
wherein the panel-carrying vehicle further includes a camera, and
wherein the panel-carrying vehicle compares a current voltage value of the battery with a running voltage value for the second route and determines to move along the first route or the second route, in a state in which the camera recognizes an external predetermined image.

12. The system of claim 1, wherein the panel-carrying vehicle is provided in plural,
wherein each of a plurality of panel-carrying vehicles moves along a first route, which passes through the battery-replacing unit, and a second route which passes through a parking area, in which the plurality of panel-carrying vehicles stand by without passing through the battery-replacing unit,
wherein the control server checks a state of the battery of each of the plurality of panel-carrying vehicles, based on the first battery information, and
wherein the control server instructs at least one second panel-carrying vehicle, which is placed before a first panel-carrying vehicle having the battery to be replaced, among the plurality of panel-carrying vehicles to move to a last row of the parking area, along the second route, and instructs the first panel-carrying vehicle having the battery to be replaced to move along the first route.

13. A method for controlling to charge a vehicle, the method comprising:
providing a plurality of panel-carrying vehicles including a battery, a battery-replacing unit to receive a replacing battery, and a control server;
reporting, by the battery-replacing unit, a battery information and a unit information to the control server, at every first time interval;
determining whether the replacing battery is replaceable;
determining a replacing panel-carrying vehicle, which has the battery to be replaced, among the plurality of panel-carrying vehicles;
selecting, by the control server, the battery-replacing unit next to the replacing panel-carrying vehicle, based on the unit information, and transmitting a moving instructing signal to the replacing panel-carrying vehicle;
instructing the replacing panel-carrying vehicle to move to the battery-replacing unit next to the replacing panel-carrying vehicle; and
transmitting, by the battery-replacing unit, an information about the replacing battery, which is replaced, to the control server.

14. The method of claim 13, wherein the battery-replacing unit includes:
a temperature sensor, and
wherein the unit information includes:
an information about a temperature of the battery-replacing unit, which is measured by the temperature sensor.

15. The method of claim 13, wherein the replacing battery has an information about an identifier; and
wherein the battery information includes the information about the identifier.

16. The method of claim 13, wherein the battery information includes an information about a voltage or a current of the replacing battery.

17. The method of claim 13, wherein the panel-carrying vehicle moves along a first route, which passes through the battery-replacing unit, or a second route which does not pass through the battery-replacing unit, and
wherein the panel-carrying vehicle further includes a camera.

18. The method of claim 17, wherein the panel-carrying vehicle compares a current voltage value of the battery with a running voltage value for the second route and determines to move along the first route or the second route, in a state in which the camera recognizes an external predetermined node.

19. The method of claim 13, wherein each of the plurality of panel-carrying vehicles moves along a first route, which passes through the battery-replacing unit, and a second route which passes through a parking area, in which the plurality of panel-carrying vehicles stand by without passing through the battery-replacing unit, and
wherein the control server checks a state of the battery of each of the plurality of panel-carrying vehicles.

20. The method of claim 19, further comprising:
instructing at least one second panel-carrying vehicle, which is placed before a first panel-carrying vehicle having the battery to be replaced, among the plurality of panel-carrying vehicles to move to a last row of the parking area, along the second route; and
instructing the first panel-carrying vehicle having the battery to be replaced to move along the first route.
